(19) United States
(12) Patent Application Publication
(10) Pub. No.: US 2024/0095583 A1
(43) Pub. Date: Mar. 21, 2024

(54) MACHINE LEARNING TRAINING APPROACH FOR A MULTITASK PREDICTIVE DOMAIN

(71) Applicant: UnitedHealth Group Incorporated, Minnetonka, MN (US)

(72) Inventors: George AUSTIN, Maplewood, NJ (US); Eran HALPERIN, Santa Monica, MN (US); Fazlolah MOHAGHEGH, Frisco, TX (US); Aldo CORDOVA PALOMERA, San Diego, CA (US)

(21) Appl. No.: 18/155,228

(22) Filed: Jan. 17, 2023

Related U.S. Application Data
(60) Provisional application No. 63/375,585, filed on Sep. 14, 2022.

(51) Int. Cl. G06N 20/00

(52) U.S. Cl. CPC G06N 20/00

(57) ABSTRACT

Various embodiments of the present disclosure disclose a machine learning training approach for intelligently training a plurality of machine learning models associated with a multitask environment. The techniques include jointly training the plurality of machine learning models based on task similarities by generating a similarity matrix corresponding to a plurality machine learning models, generating a sharing loss value for the at least two machine learning models, generating, using a loss function and a training dataset, a prediction loss value for a particular machine learning model of the at least two machine learning models, generating an aggregated loss value for the particular machine learning model based on the similarity matrix, the sharing loss value, and the prediction loss value, and updating the particular machine learning model based on the aggregated loss value for the particular machine learning model.

### CROSS-REFERENCE TO RELATED APPLICATIONS

This application claims the benefit of U.S. Provisional Application No. 63/375,585, entitled “APPLICATION OF BAYESIAN INFERENCE TO MEDICAL CODES IN A MULTITASK LEARNING ENVIRONMENT,” and filed Sep. 14, 2022, the entire contents of which are hereby incorporated by reference.

### BACKGROUND

Various embodiments of the present disclosure address technical challenges related to multitask learning architectures given limitations of existing machine learning processes. Existing processes for handling multitask environments, for example, may lack sufficient training data to adequately train machine learning models, which may inhibit the predictive capabilities of such models. Some approaches attempt to overcome the technical challenges presented by minimal training data by jointly training machine learning models based on task similarities. However, while these approaches may improve the predictive capabilities of the jointly trained models, the performance of the resulting models are damped by unrelated aspects of the similar tasks. Various embodiments of the present disclosure make important contributions to various existing multitask learning architectures by addressing each of these technical challenges.

### BRIEF SUMMARY

Various embodiments of the present disclosure disclose a machine learning training approach for training machine learning models in a multitask environment. The machine learning training approach leverages a new machine learning framework that jointly trains a plurality of machine learning models based on, but not constrained by, task similarities. The machine learning framework enables the intelligent sharing of machine learning parameters across the plurality of machine learning models based on a code similarity between models, while optimizing the predictive performance of each model. In this way, using some of the techniques described herein, a machine learning training approach may be implemented that produces machine learning models that leverage task similarities to improve prediction accuracies, but are not strictly bound by such similarities. By doing so, the present disclosure provides improved machine learning techniques that overcome the technical challenges of minimal training data in a multitask environment without dampening the predictive capabilities of a plurality of machine learning models for the multitask environment.

In some embodiments, a computer-implemented method comprises generating, by one or more processors, a similarity matrix corresponding to a plurality machine learning models, wherein the similarity matrix is indicative of a code similarity value between at least two machine learning models of the plurality of machine learning models; generating, by the one or more processors, a sharing loss value for the at least two machine learning models, wherein the sharing loss value is based at least in part on a measured dissimilarity between the at least two machine learning models; generating, by the one or more processors and using a loss function and a training dataset, a prediction loss value for a particular machine learning model of the at least two machine learning models; generating, by the one or more processors, an aggregated loss value for the particular machine learning model based at least in part on the similarity matrix, the sharing loss value, and the prediction loss value; and updating, by the one or more processors, the particular machine learning model based at least in part on the aggregated loss value for the particular machine learning model.

In some embodiments, a computing apparatus comprising at least one processor and at least one memory including program code is provided. The at least one memory and the program code are configured to, upon execution by the at least one processor, cause the computing apparatus to: generate a similarity matrix corresponding to a plurality machine learning models, wherein the similarity matrix is indicative of an code similarity value between at least two machine learning models of the plurality of machine learning models; generate a sharing loss value for the at least two machine learning models, wherein the sharing loss value is based at least in part on a measured dissimilarity between the at least two machine learning models; generate, using a loss function and training dataset, a prediction loss value for a particular machine learning model of the at least two machine learning models; generate an aggregated loss value for the particular machine learning model based at least in part on the similarity matrix, the sharing loss value, and the prediction loss value; and update the particular machine learning model based at least in part on the aggregated loss value for the particular machine learning model.

In some embodiments, a non-transitory computer-readable storage medium includes instructions that when executed by a computer, cause one or more processors to: generate a similarity matrix corresponding to a plurality machine learning models, wherein the similarity matrix is indicative of a code similarity value between at least two machine learning models of the plurality of machine learning models; generate a sharing loss value for the at least two machine learning models, wherein the sharing loss value is based at least in part on a measured dissimilarity between the at least two machine learning models; generate, using a loss function and training dataset, a prediction loss value for a particular machine learning model of the at least two machine learning models; generate an aggregated loss value for the particular machine learning model based at least in part on the similarity matrix, the sharing loss value, and the prediction loss value; and update the particular machine learning model based at least in part on the aggregated loss value for the particular machine learning model.

### BRIEF DESCRIPTION OF THE DRAWINGS

FIG. 1 is a schematic diagram showing an example computing system for generating predictive insights using distributions of non-descriptive identifiers in accordance with some embodiments of the present disclosure.

FIG. 2 is a schematic diagram showing a system computing architecture in accordance with some embodiments discussed herein.

FIG. 3 is a flowchart showing an example of a process for jointly training a plurality of machine learning models in a multitask learning environment based on task similarities in accordance with some embodiments discussed herein.

FIG. 4 provides a dataflow diagram showing example data structure representations for jointly training a plurality of machine learning models in a multitask learning environment based on task similarities in accordance with some embodiments discussed herein.

FIG. 5 provides an operational example of a similarity matrix in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts may be used to perform other types of data analysis.

### I. Overview, Technical Improvements, and Technical Advantages

Embodiments of the present disclosure present new machine learning techniques that improve machine learning model performance in a multitask environment. To do so, the present disclosure provides a machine learning training approach that leverages a new learning framework for jointly training a plurality of models based on inferred similarities between the models. In some embodiments, the inferred similarities between the models are updated through an iterative training process to improve the machine learning performance (e.g., accuracy, reliability, and/or the like as measured through one or more loss functions) of each of a plurality of machine learning models associated with the multitask environment. The multitask environment, for example, may include a prediction domain in which a suite of machine learning models are used to make predictions tailored to specific prediction classes within the prediction domain. In some embodiments, the new learning framework jointly train each of the prediction models based on an inferred similarity of each of the prediction classes and then iteratively refine the inferred similarities based on the prediction accuracy of the machine learning models. In this way, the present disclosure provides improved machine learning techniques for multitask environments in which machine learning models are intelligently, jointly trained without being constrained to initial similarity assumptions.

Generally, machine learning in multitask environments present several technical problems including, for example, limited access to training data and, when prediction classes are pooled together, performance degradations due to dissimilarities between the pooled prediction classes. For example, in some cases, a prediction domain may include a plurality of prediction classes defined with a high degree of specificity which may result in small sample sizes for each prediction class and, as a result, limited predictive capabilities of class-specific machine learning models tailored to the prediction classes. Small sample sizes may be mitigated by grouping similar prediction classes together. The similarity between prediction classes, however, may be subjective, difficult to reliably define, and resource intensive. At times, prediction classes that appear similar may nevertheless require significantly different predictive processes. Moreover, even if grouped effectively, the grouped prediction classes may still have several variations that may limit the predictive capabilities of machine learning models jointly trained based on the assumed prediction class similarities.

To address these technical problems among others, aspects of the present disclosure present new data structures and a new learning framework to reliably quantify the similarity among prediction classes within a prediction domain and improve the predictive capabilities of each of a plurality of machine learning models associated with the prediction domain. In some embodiments, the new data structures include a plurality of matrices defining attributes of and relationships between each of the plurality of machine learning models of a prediction domain. The matrices, for example, may include a similarity matrix that describes an inferred similarity between each of the machine learning models and a prediction loss matrix that describes a relative predictive performance of the machine learning models. In some embodiments, the new learning framework iteratively refines both the machine learning models and the similarity matrix based on the predictive performance of the machine learning models. In this way, the inferred similarity between each of the machine learning models is intelligently refined to improve the predictive performance across all machine learning models associated with the prediction domain.

In some embodiments, the learning framework includes a Bayesian framework that accounts for variations across prediction classes by assuming an underlying probability that pairs of prediction classes are equivalent. The learning framework may utilize probabilistic modeling to produce machine learning models not strictly bound by such similarity assumptions, while leveraging the similarity assumptions when they improve the predictive performance of the machine learning models.

In some embodiments, the parameters of each of the plurality of machine learning models may be weighted based on the similarity (e.g., as represented by a similarity matrix, and/or the like) between prediction classes. This may induce similar distributions for similar prediction classes, the similarity of which may be strengthened or weakened based on the predictive performance of the machine learning models. For example, the similarity among prediction classes may be learned through an iterative training process to intelligently develop a hierarchy of prediction classes. This may be enabled by incorporating gradient descent updates within a Bayesian framework in which the similarities are fitted to optimize the predictive performance of each of the machine learning models.

Example inventive and technologically advantageous embodiments of the present disclosure include: (i) a learning framework for jointly training a plurality of machine learning models to improve training data available for the machine learning models, (ii) improved data structures such as similarity matrices that intelligently account for cross-class similarity measurements between machine learning models, and (iii) training techniques that iteratively account for dissimilarities between prediction classes to prevent machine learning model performance dampening through pooling machine learning models associated with unrelated prediction classes.

Various embodiments of the disclosure are described herein using several different example terms.

In some embodiments, the term “prediction class” refers to a data entity that describes a particular class of object, algorithm, model, and/or other data structure or function associated with a prediction domain. A prediction domain, for example, may include a multitask environment in which a plurality of related predictions (e.g., tasks) may be generated depending on a prediction class within the prediction domain. As one example, a prediction class may include a classification for a machine learning model that describes a purpose, functionality, or specialty of the machine learning model. A prediction class, for example, may describe a particular task associated with a respective machine learning model in a multiple model, multitask environment in which each machine learning model is tailored for a particular task (e.g., predictive task, classification task, and/or the like).

In some embodiments, the prediction class depends on the type of prediction domain and/or type or machine learning models involved in a multitask environment of the prediction domain. As one example, a prediction domain may include a prior authorization prediction domain that may involve a plurality of machine learning models individually tailored to predict outcomes for prior authorization requests that involve a particular medical code, such as a current procedural terminology (CPT) code. In such a case, a prediction class may include a particular medical code (e.g., a CPT code, etc.), and the plurality of machine learning models may include respective code-specific machine learning models individually tailored to generate respective prediction outputs for prior authorization requests corresponding to each of a plurality of medical codes (e.g., a plurality of CPT codes, etc.) of the prior authorization prediction domain.

In some embodiments, the term “machine learning model” refers to a data entity that describes parameters, hyper-parameters, and/or defined operations of a machine learning model (e.g., model including at least one of one or more rule-based layers, one or more layers that depend on trained parameters, coefficients, and/or the like). A machine learning model may be trained to perform a classification, prediction, and/or any other computing task associated with a multitask environment. A machine learning model may include one or more of any type of machine learning model including one or more supervised, unsupervised, semi-supervised, and/or reinforcement learning models. In some embodiments, the machine learning model may include multiple models configured to perform one or more different stages of a classification, predictive, and/or the like computing task.

In some embodiments, a machine learning model includes a machine learning prediction model trained, using one or more supervisory training techniques, to generate a prediction output indicative of a predicted outcome for a prior authorization request. A machine learning model may include any type of prediction model including, as examples, random generative models such as neural networks, convolutional neural networks, Bayesian networks, and/or the like. A machine learning model may include one or more models with a set number of coefficients (e.g., linear regression models, and/or the like) and/or models without a set number of coefficients (e.g., random forest models, and/or the like).

In some embodiments, a machine learning model includes a class-specific machine learning model from a plurality of class-specific machine learning models, each individually tailored to generate a prediction output for a specific class prediction prompt. One example of a specific class prediction prompt may include a prior authorization request corresponding to a particular CPT code. For example, a prior authorization request may specify a single CPT code, and each class-specific machine learning model may be configured to generate prediction outputs for prior authorization requests that specify a particular CPT code. In this way, each class-specific machine learning model may be tailored to a specific CPT code to improve reliability and accuracy of prediction outputs.

In some embodiments, the term “model matrix” refers to a data entity that describes parameters (e.g., coefficients, and/or the like) for the plurality of machine learning models associated with the prediction domain. The model matrix may include any type of data structure including, as one example, a two-dimensional data structure that represents parameters for each of the plurality of machine learning models. In some embodiments, the plurality of machine learning models may be represented as a matrix W. For example, in a prior authorization prediction domain, the matrix W may represent a separate machine learning model for each of a plurality of CPT codes. For example, Wᵢ may be configured to generate a prediction output for a prediction prompt (e.g., a prior authorization request in a prior authorization request prediction domain) corresponding to a first prediction class (e.g., a first CPT code in a prior authorization prediction domain), i, and Wⱼ may be configured to generate a prediction output for a prediction prompt (e.g., a prior authorization request in a prior authorization request prediction domain) corresponding to a second prediction class (e.g., a second CPT code in a prior authorization prediction domain), j. The model matrix may include the dimensions k×m, where k may be a number of class-specific machine learning models and/or prediction classes (e.g., CPT codes involved in a prior authorization prediction domain) associated with the prediction domain and m may be a number of predictive features obtained from a training dataset associated with the prediction domain.

In some embodiments, the term “training dataset” refers to a data entity that includes a plurality of data objects associated with the prediction domain. The type, format, and parameters of each data object may be based on the prediction domain. In some embodiments, the plurality of data objects include one or more prediction prompt data objects and/or one or more corresponding contextual data objects. A prediction prompt data object and a corresponding contextual data object may include one or more predictive parameters associated with the prediction domain. In some embodiments, a prediction prompt data object may include predictive parameters associated with a prompt for which a prediction output is desired. A contextual data object may include contextual parameters for a prediction prompt that may be predictive of the prediction output. In some embodiments, the training dataset may include ground truth outcomes that describe an outcome corresponding to the prediction prompts. A ground truth outcome, for example, may include a training label indicative of a ground truth for a prediction prompt.

As one example, the training dataset may include a plurality of data objects associated with a prior authorization prediction domain in which a machine learning model is configured to predict an outcome of a prior authorization request. In such a case, the training dataset may include a prediction prompt data object that describes a prior authorization request. The predictive parameters of the prediction prompt data object may identify a CPT code, a patient, and/or any other attribute corresponding to the prior authorization request. The contextual data object may describe a patient medical history for a patient of a plurality of patients leading up to the prior authorization request. The contextual parameters may include any of a number of different data fields including, as examples, a blood pressure field associated with a blood pressure number and date, a free text field associated with a medical note, and/or the like. The training outcomes, in this scenario, may include prior authorization decisions corresponding to at least one of the prior authorization requests and/or the patients.

In some embodiments, the training dataset includes sub-datasets X and y, where X may include an n×m matrix that represents each patient's medical claims history and demographics, and y may include vectors of length n containing the ground truth outcomes defining prior authorization decisions for each patient. In some embodiments, at least one of the sub-datasets X and y are generated from medical claims and/or prior authorization data describing a plurality of historical prior authorization requests. In some embodiments, at least a portion of the training dataset are received, collected, and/or provided by one or more external computing entities.

In some embodiments, the term “similarity matrix” refers to a data entity that describes a code similarity value between two machine learning models of a plurality of machine learning models associated with a prediction domain. A similarity matrix may include any type of data structure including, as one example, a two-dimensional data structure that represents a code similarity value for a pair of machine learning models. A code similarity value for a pair of machine learning models may be indicative of a predictive similarity between (i) a set of coefficients respectively corresponding to each model and/or (ii) prediction outputs respectively generated using each model.

In some embodiments, a similarity matrix includes a respective code similarity value for each pair of machine learning models of the plurality of machine learning models associated with a prediction domain (e.g., a prior authorization prediction domain, and/or the like). In some embodiments, a similarity matrix is denoted as S and includes the dimensions k×k, where k is a number of class-specific machine learning models and/or prediction classes (e.g., CPT codes involved in a prior authorization prediction domain) associated with a prediction domain. Each individual code similarity value S_{i,j} of a similarity matrix may represent a code similarity between a first class-specific machine learning model associated with a first prediction class (e.g., a first CPT code in a prior authorization prediction domain), i, and a second class-specific machine learning model associated with a second prediction class (e.g., a second CPT code in a prior authorization prediction domain), j.

In some embodiments, the term “sharing loss matrix” refers to a data entity that describes a measured dissimilarity between two machine learning models. In some embodiments, the sharing loss matrix includes any type of data structure including, as one example, a two-dimensional data structure that represents a sharing loss value for a pair of machine learning models. The sharing loss value for a pair of machine learning models may be indicative of a measured dissimilarity between (i) a set of coefficients respectively corresponding to each model and/or (ii) prediction outputs respectively generated using each model. In some embodiments, the measured dissimilarity between two machine learning models includes a distance measure between the models. The distance measure may be determined using an L1, L2, and/or any other loss function. In some embodiments, the distance measure includes a distance (e.g., Euclidean distance, and/or the like) between coefficients of the two models and/or an output difference between outputs of the two models.

In some embodiments, the sharing loss matrix includes a respective sharing loss value for each pair of machine learning models of a plurality of machine learning models associated with the prediction domain (e.g., prior authorization prediction domain, and/or the like). In some embodiments, the sharing loss matrix is denoted as D and includes dimensions k×k, where k may be the number of class-specific machine learning models and/or prediction classes (e.g., CPT codes involved in a prior authorization prediction domain) associated with a prediction domain. Each individual value D_{i,j} in the sharing loss matrix may represent a sharing loss value between a first class-specific machine learning model associated with a first prediction class (e.g., a first CPT code in a prior authorization prediction domain), i, and a second class-specific machine learning model associated with a second prediction class (e.g., a second CPT code in a prior authorization prediction domain), j.

In some embodiments, the sharing loss values of the sharing loss matrix, D, may be calculated by the machine learning models represented by the model matrix, W, which may be 054642/588896 generated by optimizing predictions (e.g., for XW^{T}=y where X may be described by the training dataset and T may denote a matrix transpose). The similarity matrix, S, may be representative of an estimate of how similar the machine learning models represented by the model matrix, W, should be.

In some embodiments, the term “sharing-similarity loss matrix” refers to a data entity that describes a scaled sharing loss value between two machine learning models. In some embodiments, a sharing-similarity loss matrix includes any type of data structure including, as one example, a two-dimensional data structure that represents a scaled sharing loss value for a pair of machine learning models. The scaled sharing loss value for a pair of machine learning models may include a sharing loss value for the pair of machine learning models scaled through multiplication (and/or any other aggregation techniques) by a code similarity value for the pair of machine learning models.

In some embodiments, the sharing-similarity loss matrix includes a sharing-similarity loss value (e.g., a scaled sharing loss value) for each pair of machine learning models represented by the model matrix, W. By way of example, the sharing-similarity loss matrix, SD, may include the similarity matrix, S, multiplied by the sharing loss matrix, D. In some embodiments, the machine learning models may be trained to minimize SD to ensure that models for similar prediction classes are similar.

In some embodiments, the term “prediction loss matrix” refers to a data entity that describes a prediction loss value for a machine learning model. A prediction loss value may be indicative of a predictive performance (e.g., accuracy, and/or the like) of a machine learning model. The predictive performance of a machine learning model, for example, may be determined by applying a loss function to prediction outputs from a machine learning model relative to corresponding ground truth outcomes. The loss function may include any type of loss function including, as examples, binary cross-entropy loss, and/or the like. In some embodiments, the prediction loss matrix includes a prediction loss value for each of the plurality of machine learning models represented by the model matrix, W, relative to ground truth outcomes (e.g., observed prior authorization outcomes). The prediction loss matrix may be represented as a matrix of n×l dimensions, where n may represent a total number of contextual data objects (e.g., patients in a prior authorization prediction domain) among all prediction classes (e.g., CPT codes in a prior authorization prediction domain).

In some embodiments, the term “aggregated loss value” refers to a data entity that describes the joint loss for a plurality of machine learning models associated with a prediction domain. The aggregated loss value, for example, may include a combination of the sharing-similarity loss matrix and the prediction loss matrix. By way of example, the aggregated loss value may be the weighted sum of prediction loss matrix (e.g., the predictive performance of the machine learning models) and the sharing-similarity loss matrix (e.g., the sharing loss matrix, D, scaled through multiplication by similarity matrix, S). The aggregated loss value may include a single value (e.g., a single number) indicative of the combination of the sharing-similarity loss matrix and the prediction loss matrix.

### II. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a nonvolatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a non-transitory computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### III. Example Computing System

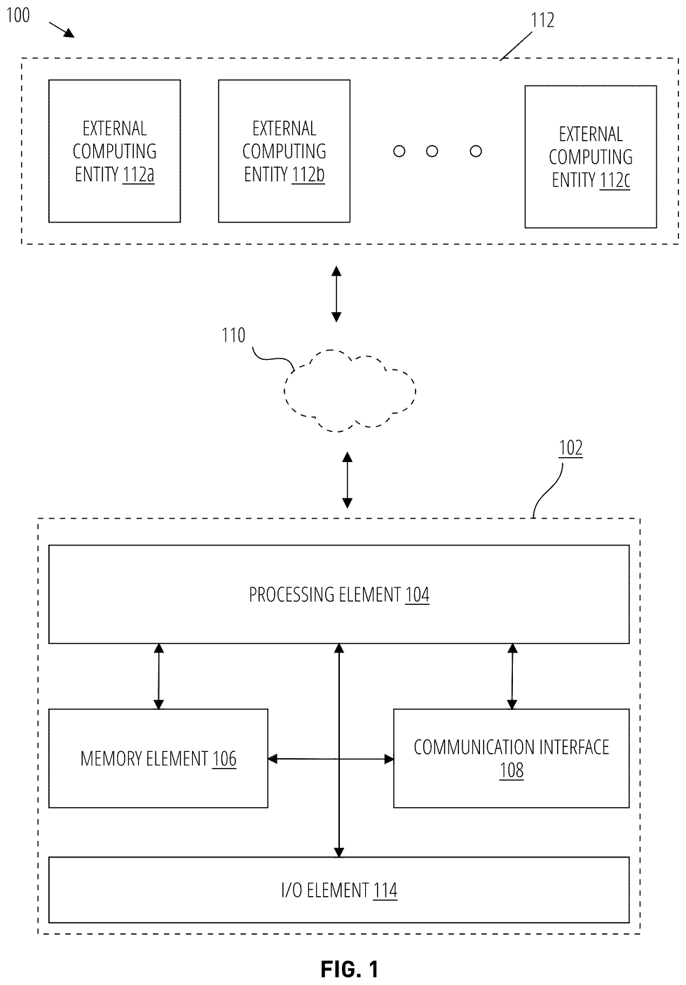

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more prediction techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more prediction techniques described herein.

The external computing entities 112a-c, for example, may include and/or be associated with one or more data centers. The data centers, for example, may be associated with one or more data repositories storing data that can, in some circumstances, be processed by the predictive computing entity 102. By way of example, the external computing entities 112a-c may be associated with a plurality of predictive entities associated with a multitask environment such as a prediction domain (e.g., a prior authorization prediction domain, and/or the like) in which a plurality of different prediction outputs are desired for prediction prompts (e.g., prior authorization requests associated with a prior authorization prediction domain, and/or the like) involving different prediction classes (e.g., CPT codes associated with a prior authorization prediction domain, and/or the like). In addition, or alternatively, the external computing entities 112a-c may include one or more data processing entities that may receive, store, and/or have access to historical prior authorization requests/outcomes for the historical requests and/or contextual data (e.g., patient data, and/or the like) that may be used as a training dataset for machine learning models of a prediction domain (e.g., prior authorization prediction domain). As one example, in a prior authorization context, a first example external computing entity 112a may include a health care provider that receives a prior authorization request involving a particular CPT code.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities such as the external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

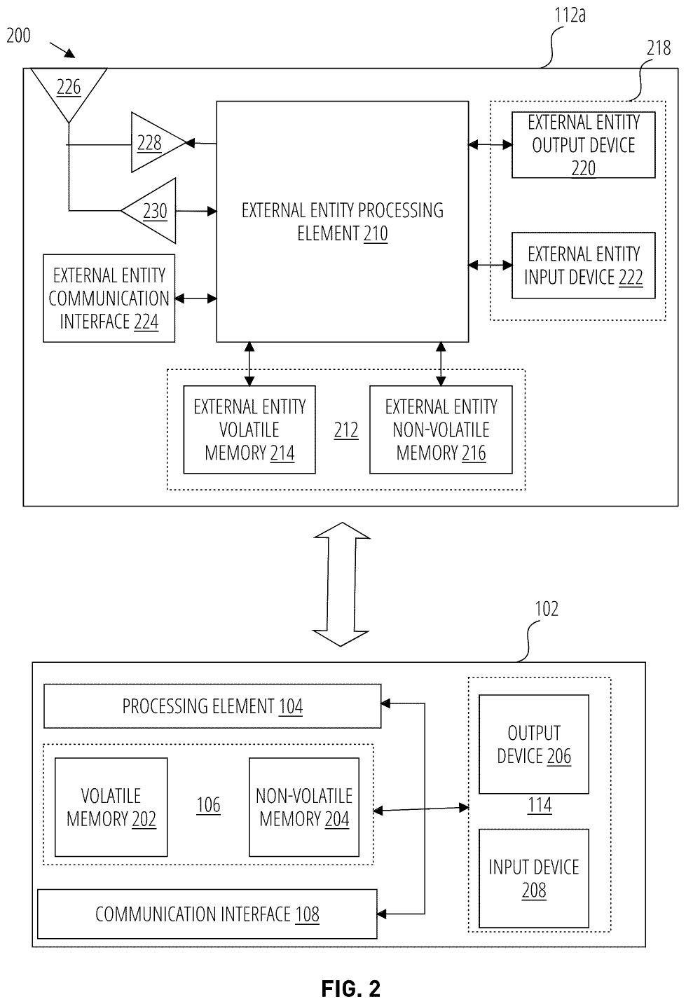

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry such as a communication bus, and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established, or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry such as a communication bus, and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above regarding the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Example System Operations

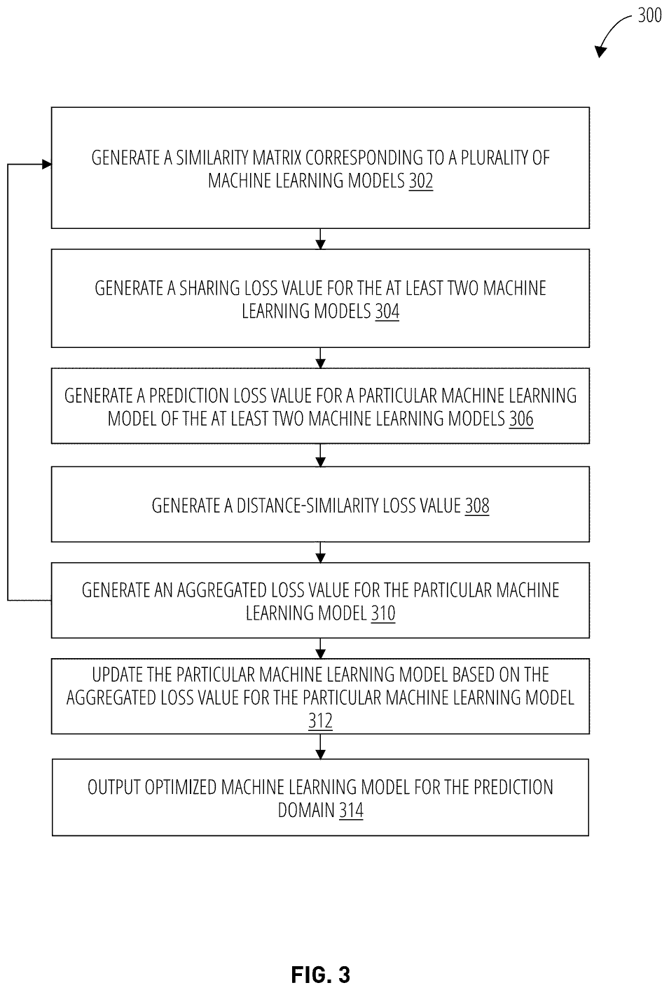

FIG. 3 is a flowchart showing an example of a process 300 for jointly training a plurality of machine learning models in a multitask learning environment based on task similarities in accordance with some embodiments discussed herein. The flowchart depicts a machine learning framework for intelligently training a plurality of machine learning models based on task similarity. The machine learning framework may be implemented by one or more computing devices, entities and/or systems described herein. For example, via the various steps/operations of the process 300, the computing system 100 may leverage the machine learning architecture to overcome the various limitations with conventional training techniques that (i) lack comprehensive training data and/or (ii) are strictly bound by task similarity and, as a result, lack predictive accuracy, reliability, and practicality.

FIG. 3 illustrates an example process 300 for explanatory purposes. Although the example process 300 depicts a particular sequence of steps/operations, the sequence may be altered without departing from the scope of the present disclosure. For example, some of the steps/operations depicted may be performed in parallel or in a different sequence that does not materially impact the function of the process 300. In other examples, different components of an example device or system that implements the process 300 may perform functions at substantially the same time or in a specific sequence.

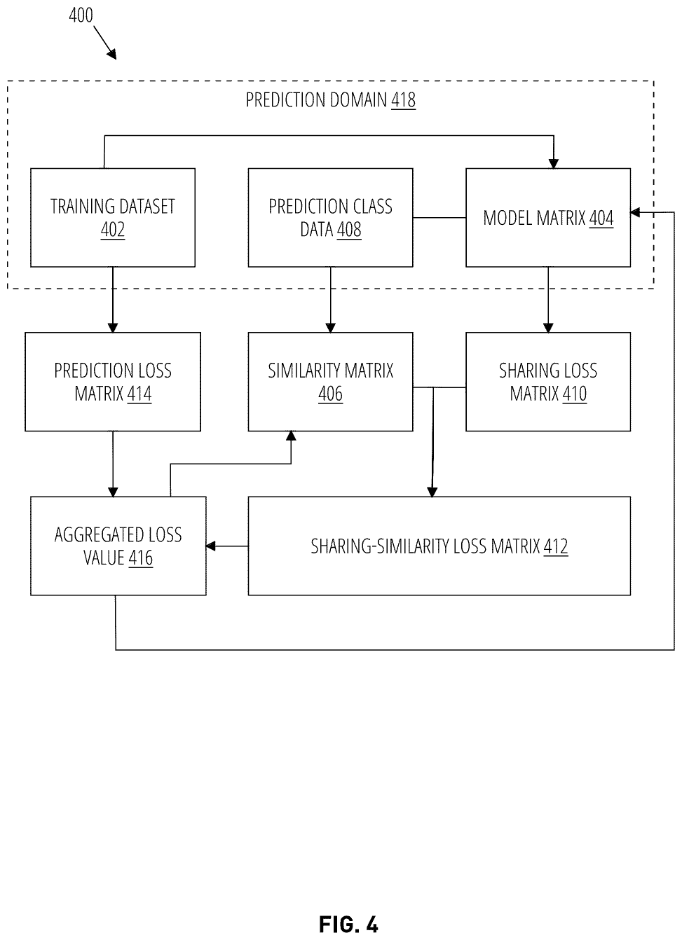

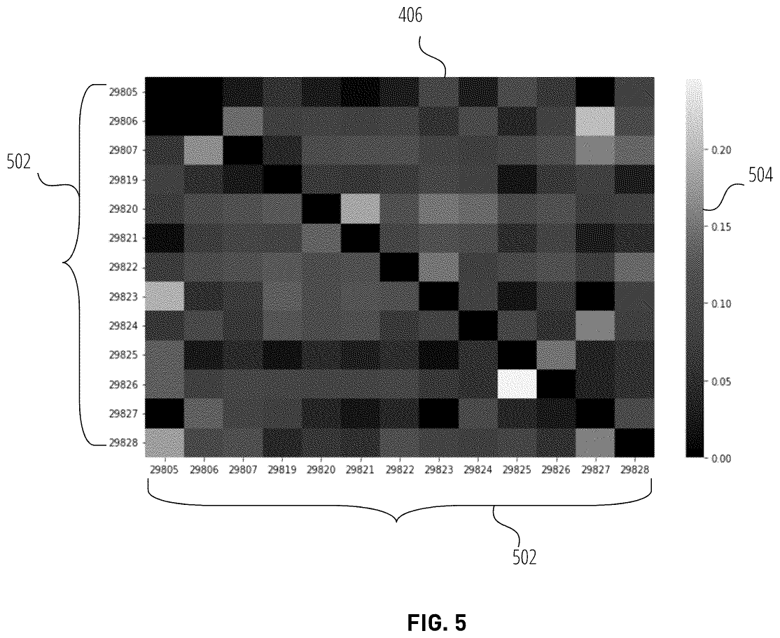

The process 300 includes, at step/operation 302, generating a similarity matrix corresponding to a plurality of machine learning models. For example, the computing system 100 may generate the similarity matrix corresponding to the plurality of machine learning models. The similarity matrix may be indicative of a code similarity between at least two machine learning models of the plurality of machine learning models. Examples of the similarity matrix will now be described with reference to FIGS. 4 and 5.

FIG. 4 provides a dataflow diagram 400 showing example data structure representations for jointly training a plurality of machine learning models in a multitask learning environment based on task similarities in accordance with some embodiments discussed herein. The dataflow diagram 400 depicts a hierarchical set of data structures including matrices, predictive values, and/or the like that may be iteratively modified to enhance the predictive performance of a plurality of machine learning models for a prediction domain 418. By iteratively modifying the hierarchical set of data structures, the predictive performance of the plurality of machine learning models may be intelligently improved by leveraging similarities across machine learning models without being constrained by such similarities.

The dataflow diagram 400 includes a similarity matrix 406. The similarity matrix 406 may include a data entity that describes a code similarity value between two machine learning models of a plurality of machine learning models associated with the prediction domain 418. The similarity matrix 406 may include any type of data structure including, as one example, a two-dimensional data structure that represents a code similarity value for a pair of machine learning models. The code similarity value for a pair of machine learning models may be indicative of a predictive similarity between (i) a set of coefficients respectively corresponding to each model and/or (ii) prediction outputs respectively generated using each model.

In some embodiments, the similarity matrix 406 may include a respective code similarity value for each pair of machine learning models of the plurality of machine learning models associated with the prediction domain 418 (e.g., a prior authorization prediction domain, and/or the like). By way of example, the similarity matrix 406 may be denoted as S and may include the dimensions k×k, where k is a number of class-specific machine learning models and/or prediction classes (e.g., CPT codes involved in a prior authorization prediction domain) associated with the prediction domain 418. Each individual code similarity value S_{i,j} of the similarity matrix 406 may represent a code similarity between a first class-specific machine learning model associated with a first prediction class (e.g., a first CPT code in a prior authorization prediction domain), i, and a second class-specific machine learning model associated with a second prediction class (e.g., a second CPT code in a prior authorization prediction domain), j.

FIG. 5 provides an operational example of a similarity matrix 406 in accordance with some embodiments discussed herein. The similarity matrix 406 may include a plurality of data fields each respectively corresponding to a pair of prediction classes 502. Each field may be indicative of a degree of similarity (e.g., a code similarity value) between a respective pair of prediction classes. In some embodiments, the degree of similarity may be represented by a color scale 504. By way of example, the similarity matrix 406 may be represented as a heatmap in which a color intensity of a respective field is descriptive of the code similarity value corresponding to a pair of prediction classes 502. The heat map may represent a collection of fitted similarities that are optimized to the predictive performance of a plurality of machine learning models respectively tailored to each of the prediction classes 502 of a prediction domain. In a prior authorization context, the heatmap may correspond to a CPT code hierarchy through a hierarchical clustering model.

Turning back to FIG. 4, the similarity matrix 406 may be initially generated based on prediction class data 408 that describes a plurality of prediction classes of the prediction domain 418.

A prediction class may refer to a data entity that describes a particular class of object, algorithm, model, and/or other data structure or function associated with a prediction domain 418. The prediction domain 418, for example, may include a multitask environment in which a plurality of related predictions (e.g., tasks) may be generated depending on a prediction class within the prediction domain 418. As one example, a prediction class may include a classification for a machine learning model that describes a purpose, functionality, or specialty of the machine learning model. A prediction class, for example, may describe a particular task associated with a respective machine learning model in a multiple model, multitask environment in which each machine learning model is tailored for a particular task (e.g., predictive task, classification task, and/or the like).

In some embodiments, the prediction class depends on the type of prediction domain and/or type or machine learning models involved in a multitask environment of the prediction domain. As one example, in some embodiments, the prediction domain may include a prior authorization prediction domain that may involve a plurality of machine learning models individually tailored to predict outcomes for prior authorization requests that involve a particular current procedural terminology (CPT) code. In such a case, a prediction class may include a particular CPT code and the plurality of machine learning models may include respective code-specific machine learning models individually tailored to generate respective prediction outputs for prior authorization requests corresponding to each of the plurality of CPT codes of the prior authorization prediction domain.

In some embodiments, the plurality of prediction classes of the prediction domain 418 is described by the prediction class data 408. The prediction class data 408, for example, may describe a label associated with each prediction class, contextual data for each prediction class, and/or the like. As one example, the prediction classes may be respectively associated with one or more textual descriptions (e.g., one or more transcribed words, phrases, and/or the like) that describe a particular task corresponding to the respective prediction class. The prediction class data 408 may include a plurality of textual descriptions corresponding to the prediction classes. As one example, in a prior authorization prediction domain, a prediction class may describe a corresponding CPT code and, in some embodiments, the prediction class data 408 may include a textual description corresponding to each CPT code.

In some embodiments, the textual description for each prediction class includes one or more different textual characteristics derived from one or more different data sources (e.g., external computing entities 112a-c). By way of example, the textual description for a prediction class may include a standardized textual description assigned by a standardization agency. In addition, or alternatively, the textual description may be derived from one or more textual phrases, words, descriptors, and/or the like that correspond to the prediction class and are provided by one or more third parties (e.g., research institutions, journals, and/or the like). A textual description, for example, may include one or more phrases, words, descriptors, and/or the like extracted from one or more documents (e.g., scientific journals, medical notations, and/or the like) associated with the prediction domain 418.

In some embodiments, the prediction domain 418 includes a plurality of different machine learning models each specifically tailored to perform at least one of the multiple prediction tasks of the prediction domain 418. For example, a machine learning model may refer to a data entity that describes parameters, hyper-parameters, and/or defined operations of a machine learning model (e.g., model including at least one of one or more rule-based layers, one or more layers that depend on trained parameters, coefficients, and/or the like). A machine learning model may be trained to perform a classification, prediction, and/or any other computing task associated with a multitask environment. The machine learning model may include one or more of any type of machine learning model including one or more supervised, unsupervised, semi-supervised, and/or reinforcement learning models. In some embodiments, the machine learning model may include multiple models configured to perform one or more different stages of a classification, predictive, and/or the like computing task.

As one example, a machine learning model may include a machine learning prediction model trained, using one or more supervisory training techniques, to generate a prediction output indicative of a predicted outcome for a prior authorization request. A machine learning model may include any type of prediction model including, as examples, random generative models such as neural networks, convolutional neural networks, Bayesian networks, and/or the like. A machine learning model may include one or more models with a set number of coefficients (e.g., linear regression models, and/or the like) and/or models without a set number of coefficients (e.g., random forest models, and/or the like).

In some embodiments, a machine learning model may include a class-specific machine learning model from a plurality of class-specific machine learning models each individually tailored to generate a prediction output for a specific class prediction prompt. One example of a specific class prediction prompt may include a prior authorization request corresponding to a particular CPT code. For example, a prior authorization request may specify a single CPT code and each class-specific machine learning model may be configured to generate prediction outputs for prior authorization requests that specify a particular CPT code. In this way, each class-specific machine learning model may be tailored to a specific CPT code to improve reliability and accuracy of prediction outputs.

In some embodiments, the plurality of class-specific machine learning models may be represented by a model matrix 404. The model matrix 404 may refer to a data entity that describes parameters (e.g., coefficients, and/or the like) for the plurality of machine learning models associated with the prediction domain 418. The model matrix 404 may include any type of data structure including, as one example, a two-dimensional data structure that represents parameters for each of the plurality of machine learning models. For example, the plurality of machine learning models may be represented as a matrix W. In a prior authorization prediction domain, the matrix W may represent a separate machine learning model for each of a plurality of CPT codes. For example, Wᵢ may be configured to generate a prediction output for a prediction prompt (e.g., a prior authorization request in a prior authorization request prediction domain) corresponding to a first prediction class (e.g., a first CPT code in a prior authorization prediction domain), i, and Wⱼ may be configured to generate a prediction output for a prediction prompt (e.g., a prior authorization request in a prior authorization request prediction domain) corresponding to a second prediction class (e.g., a second CPT code in a prior authorization prediction domain), j. The model matrix 404 may include the dimensions k×m, where k may be a number of class-specific machine learning models and/or prediction classes (e.g., CPT codes involved in a prior authorization prediction domain) associated with the prediction domain 418 and m may be a number of predictive features obtained from a training dataset 402 associated with the prediction domain 418.

The training dataset 402, for example, may include a data entity that includes a plurality of data objects associated with the prediction domain 418. The type, format, and parameters of each data object may be based on the prediction domain 418. For example, the plurality of data objects may include one or more prediction prompt data objects and/or one or more corresponding contextual data objects. A prediction prompt data object and a corresponding contextual data object may include one or more predictive parameters associated with the prediction domain 418. For example, a prediction prompt data object may include predictive parameters associated with a prompt for which a prediction output is desired. A contextual data object may include contextual parameters for a prediction prompt that may be predictive of the prediction output. In some embodiments, the training dataset 402 may include ground truth outcomes that describe an outcome corresponding to the prediction prompts. A ground truth outcome, for example, may include a training label indicative of a ground truth for a prediction prompt.

As one example, the training dataset 402 may include a plurality of data objects associated with a prior authorization prediction domain in which a machine learning model is configured to predict an outcome of a prior authorization request. In such a case, the training dataset 402 may include a prediction prompt data object that describes a prior authorization request. The predictive parameters of the prediction prompt data object may identify a CPT code, a patient, and/or any other attribute corresponding to the prior authorization request. The contextual data object may describe a patient medical history for a patient of a plurality of patients leading up to the prior authorization request. The contextual parameters may include any of a number of different data fields including, as examples, a blood pressure field associated with a blood pressure number and date, a free text field associated with a medical note, and/or the like. The training outcomes, in this scenario, may include prior authorization decisions corresponding to at least one of the prior authorization requests and/or the patients.

In some embodiments, the training dataset 402 may include sub-datasets X and y, where X may include an n×m matrix that represents each patient's medical claims history and demographics, and y may include vectors of length n containing the ground truth outcomes defining prior authorization decisions for each patient. In some embodiments, at least one of the sub-datasets X and y may be generated from medical claims and/or prior authorization data describing a plurality of historical prior authorization requests. In some embodiments, at least a portion of the training dataset 402 may be received, collected, and/or provided by one or more external computing entities 112a-c.

In some embodiments, the high degree of prediction class specificity, such as the specificity of specific CPT codes, may result in small sample sizes for each prediction class (e.g., CPT code) and resultingly low predictive power for each class-specific machine learning model associated with the prediction domain 418. In some embodiments, grouping similar prediction classes together for analysis may increase sample sizes and predictive power despite increases in variation due to differences among the grouped prediction classes. However, determining similarity among different prediction classes may be subjective and highly resource intensive. Similar prediction classes (e.g., CPT codes) may correspond to similar tasks, but tasks that appear similar may behave very differently with respect to predicting outcomes for a prediction prompt such as a prior authorization request. Some of the aspects of the present disclosure provide techniques to improve the accuracy and reliability of each of the class-specific machine learning models by quantifying the similarity among prediction classes (e.g., CPT codes) and jointly training the models based on the discovered code similarity values.

The similarity matrix 406, for example, may enable the quantification of the expected similarities between each of the class-specific machine learning models respectively corresponding to the plurality of prediction classes associated with the prediction domain 418. In some embodiments, the similarity matrix 406 may be initialized based on the textual descriptions corresponding to each of the prediction classes respectively corresponding to each of the plurality of class-specific machine learning models.

For example, an initial code similarity value between the at least two machine learning models (e.g., the prediction classes thereof) may be determined based on a textual similarity between (i) a first textual description associated with a first machine learning predictive model (e.g., a first prediction class) of the at least two machine learning models, and (ii) a second textual description associated with a second machine learning predictive model (e.g., a second prediction class) of the at least two machine learning models. The similarity matrix 406 may be initialized with an initial code similarity value for each pair of machine learning models of the plurality of machine learning models associated with the prediction domain 418.

By way of example, the similarity matrix 406 may be initialized by determining a Jaccard similarity (and/or any other textual comparison techniques) between textual descriptions of each pair of prediction classes (e.g., CPT code descriptions in a prior authorization prediction domain). As an example, for a prior authorization prediction domain, four example prediction classes may include four different CPT codes with textual descriptions. A first prediction class (e.g., CPT code: 33420) may include the textual description of “Under Repair, Revision, and/or Reconstruction Procedures on the Shoulder.” A second prediction class (e.g., CPT code: 33465) may include the textual description of “Under Repair, Revision, and/or Reconstruction Procedures on the Shoulder.” A third prediction class (e.g., CPT code: 33020) may include the textual description of “Under Incision Procedures on the Shoulder.” A fourth prediction class (e.g., CPT code: 99339) may include the textual description of “Under Domiciliary, Rest Home (e.g., Assisted Living Facility), or Home Care Plan Oversight Services.” A textual similarity (e.g., a Jaccard similarity, and/or the like) may assess which words are shared between the textual descriptions of each pair of prediction classes, which may correspond, in some embodiments, to the first and second prediction classes having a similarity close to 1; the first and third prediction classes having a similarity close to 0.5; and/or the first and fourth prediction classes having a similarity close to 0.

As described herein, during an iterative machine learning approach, the code similarity values may be used to assess the likelihood of a community of predictors between two class-specific machine learning models (e.g., Wᵢ and Wⱼ) in which the components between Wᵢ and Wⱼ may be assumed to follow a covariance determined by the similarity matrix 406. At the beginning of the machine learning approach, the similarity matrix 406 is populated with the initial code similarity values that may be updated after each iteration of the machine learning approach.

Turning back to FIG. 3, the process 300 includes, at step/operation 304, generating a sharing loss value for the at least two machine learning models. For example, the computing system 100 may generate the sharing loss value for the at least two machine learning models. The sharing loss value, for example, may be based on a measured dissimilarity between the at least two machine learning models. The measured dissimilarity, for example, may include a distance between the at least two machine learning models. The distance may be determined based on at least one of: (i) a Euclidean distance between one or more coefficients of the at least two machine learning models, and/or (ii) an output difference between one or more outputs of the at least two machine learning models. Examples of the sharing loss value will now be described with reference to FIG. 4.

With reference to FIG. 4, the sharing loss value for the at least two machine learning models may be represented within the sharing loss matrix 410. The sharing loss matrix 410 may refer to a data entity that describes a measured dissimilarity between two machine learning models. The sharing loss matrix 410, for example, may include any type of data structure including, as one example, a two-dimensional data structure that represents a sharing loss value for a pair of machine learning models. The sharing loss value for a pair of machine learning models may be indicative of a measured dissimilarity between (i) a set of coefficients respectively corresponding to each model and/or (ii) prediction outputs respectively generated using each model. In some embodiments, the measured dissimilarity between two machine learning models may include a distance measure between the models. The distance measure may be determined using an L1, L2, and/or any other loss function. In some embodiments, the distance measure may include a distance (e.g., Euclidean distance, and/or the like) between coefficients of the two models and/or an output difference between outputs of the two models.

In some embodiments, the sharing loss matrix 410 may include a respective sharing loss value for each pair of machine learning models of a plurality of machine learning models associated with the prediction domain 418 (e.g., prior authorization prediction domain, and/or the like). By way of example, the sharing loss matrix 410 may be denoted as D and may include dimensions k×k, where k may be the number of class-specific machine learning models and/or prediction classes (e.g., CPT codes involved in a prior authorization prediction domain) associated with the prediction domain 418. Each individual value D_{i,j} in the sharing loss matrix 410 may represent a sharing loss value between a first class-specific machine learning model associated with a first prediction class (e.g., a first CPT code in a prior authorization prediction domain), i, and a second class-specific machine learning model associated with a second prediction class (e.g., a second CPT code in a prior authorization prediction domain), j.

By way of example, the sharing loss values of the sharing loss matrix 410, D, may be calculated by the machine learning models represented by the model matrix 404, W, which may be generated by optimizing predictions (e.g., for XW^{T}=y where X may be described by the training dataset 402 and T may denote a matrix transpose). The similarity matrix 406, S, may be representative of an estimate of how similar the machine learning models represented by the model matrix 404, W, should be.

Turning back to FIG. 3, the process 300 includes, at step/operation 306, generating a prediction loss value for a particular machine learning model of the at least two machine learning models. For example, the computing system 100 may generate the prediction loss value for the particular machine learning model of the at least two machine learning models. In some embodiments, the prediction loss value may be generated using a loss function and/or a training dataset. Examples of the prediction loss value will now be described with reference to FIG. 4.

With reference to FIG. 4, the prediction loss value for the at least two machine learning models may be represented within the prediction loss matrix 414. The prediction loss matrix 414 may include a data entity that describes a prediction loss value for a machine learning model. A prediction loss value may be indicative of a predictive performance (e.g., accuracy, and/or the like) of a machine learning model. The predictive performance of a machine learning model, for example, may be determined by applying a loss function to prediction outputs from a machine learning model relative to corresponding ground truth outcomes. The loss function may include any type of loss function including, as examples, binary cross-entropy loss, and/or the like. In some embodiments, the prediction loss matrix 414 may include a prediction loss value for each of the plurality of machine learning models represented by the model matrix 404, W, relative to ground truth outcomes (e.g., observed prior authorization outcomes). The prediction loss matrix 414 may be represented as a matrix of n×l dimensions, where n may represent a total number of contextual data objects (e.g., patients in a prior authorization prediction domain) among all prediction classes (e.g., CPT codes in a prior authorization prediction domain).

Turning back to FIG. 3, the process 300 includes, at step/operation 308, generating a sharing-similarity loss matrix. For example, the computing system 100 may generate a sharing-similarity loss matrix. The sharing-similarity loss matrix, for example, may be representative of a plurality of scaled sharing loss values for the machine learning models. Examples of the sharing-similarity loss matrix will now be described with reference to FIG. 4.

With reference to FIG. 4, the sharing-similarity loss matrix 412 may include a sharing-similarity loss value for at least two machine learning models represented by the model matrix 404. The sharing-similarity loss value may include a sharing loss value for the at least two machine learning models scaled by the code similarity value between the at least two machine learning models. In this regard, the sharing loss matrix 410 may be based on the sharing loss matrix and/or the similarity matrix 406.

By way of example, the sharing-similarity loss matrix 412 may include a data entity that describes a scaled sharing loss value between two machine learning models. A sharing-similarity loss matrix 412 may include any type of data structure including, as one example, a two-dimensional data structure that represents a scaled sharing loss value for a pair of machine learning models. The scaled sharing loss value for a pair of machine learning models may include a sharing loss value for the pair of machine learning models scaled through multiplication (and/or any other aggregation techniques) by a code similarity value for the pair of machine learning models.

In some embodiments, the sharing-similarity loss matrix 412 may include a sharing-similarity loss value (e.g., a scaled sharing loss value) for each pair of machine learning models represented by the model matrix 404, W. By way of example, the sharing-similarity loss matrix 412, SD, may include the similarity matrix, S, multiplied by the sharing loss matrix, D. In some embodiments, the machine learning models may be trained to minimize SD to ensure that models for similar prediction classes are similar.

Turning back to FIG. 3, the process 300 includes, at step/operation 310, generating an aggregated loss value for the particular machine learning model. For example, the computing system 100 may generate the aggregated loss value for the particular machine learning model based on at least one of the similarity matrix (e.g., a code similarity value, and/or the like), the sharing loss matrix (e.g., a sharing loss value, and/or the like), the sharing-similarity loss matrix (e.g., a sharing-similarity loss value, and/or the like), and/or the prediction loss matrix (e.g., a prediction loss value, and/or the like). In some embodiments, the aggregated loss value for the particular machine learning model may be representative of a joint loss for each of a plurality of machine learning models associated with the prediction domain. Examples of the aggregated loss value will now be described with reference to FIG. 4.

With reference to FIG. 4, the aggregated loss value 416 may be generated based on one or more of the sharing-similarity loss matrix 412 and/or the prediction loss matrix 414. For example, the aggregated loss value 416 may include a combination of the sharing-similarity loss matrix 412 and the prediction loss matrix 414. By way of example, the aggregated loss value 416 may be the weighted sum of prediction loss matrix 414 (e.g., the predictive performance of the machine learning models) and the sharing-similarity loss matrix 412 (e.g., the sharing loss matrix 410, D, scaled through multiplication by similarity matrix 406, S). The aggregated loss value 416 may include a single value (e.g., a single number) indicative of the combination of the sharing-similarity loss matrix 412 and the prediction loss matrix 414.

The aggregated loss value 416, for example, may be generated using a statistical model. In an example, k prediction tasks may be considered. Each prediction task, Tᵢ, may include an individual prediction task for a respective prediction class. Each prediction task, Tᵢ, may be defined as a mixture of the other k−1 prediction tasks, such that there exists a probability Sᵢⱼ that a component of a prediction task Tᵢ is identical to a component of another prediction task Tⱼ. The probability, Sᵢⱼ, may indicate a probability that each regression coefficient is Wᵢₗ˜ [symbol] (Wⱼₗ, σₗ²), where σₗ² is the observed variance of the lth coefficient across W:

$${σ}_{l}^{2} = \frac{{\sum }_{i = 1}^{k} {( {W}_{il} - \overline{{W}_{* l}} )}^{2}}{k - 1} and \overline{{W}_{* l}} = \frac{1}{k} {\sum }_{i = 1}^{k} {W}_{il} .$$

The conditional probability of a specific prediction task-coefficient combination Wᵢₗ may be found by:

$$Pr ( {W}_{il} \vert S ) = {\prod }_{j = 1}^{k} {[ \frac{1}{{σ}_{l} \sqrt{2 π}} exp ( {\frac{- 1}{2} [ \frac{{W}_{il} - {W}_{jl}}{{σ}_{l}} ]}^{2} ) ]}^{P ( {T}_{i} = {T}_{j} )}$$

In some embodiments, a constraint that Sᵢⱼ=P(Tᵢ=Tⱼ) may be applied such that Σⱼ₌₁^{k}Sᵢⱼ=1, all Sᵢⱼ≥0, and Sᵢᵢ=0 . . . i.e., {Sᵢⱼ|∇j≠i} represents a probability space. Applying this model to the model matrix 404, W, may imply:

$$Pr ( W \vert S ) = {\prod }_{l = 1}^{m} {\prod }_{i = 1}^{k} {\prod }_{j = 1}^{k} {[ \frac{1}{{σ}_{l} \sqrt{2 π}} exp ( {\frac{- 1}{2} [ \frac{{W}_{il} - {W}_{jl}}{{σ}_{l}} ]}^{2} ) ]}^{{S}_{ij}}$$

This may lead to the log-likelihood of:

$$log [ Pr ( W \vert S ) ] = {\sum }_{l = 1}^{m} {\sum }_{i = 1}^{k} {\sum }_{j = 1}^{k} - {\frac{{S}_{ij}}{2 {σ}_{l}^{2}} [ {W}_{il} - {W}_{jl} ]}^{2} + {S}_{ij} log ( \frac{1}{{σ}_{l} \sqrt{2 π}} )$$

$$log [ Pr ( W \vert S ) ] = {\sum }_{l = 1}^{m} [ - k log ( {σ}_{l} \sqrt{2 π} ) + {\sum }_{i = 1}^{k} {\sum }_{j = 1}^{k} - {\frac{{S}_{ij}}{2 {σ}_{l}^{2}} [ {W}_{il} - {W}_{jl} ]}^{2} ]$$

This component may be combined with the logistic regression and/or loss penalty (e.g., L1, L2, and/or the like) log-likelihoods to generate the aggregated loss value 416. The aggregated loss value 416, for example, may include a negative of the following equation:

$$log [ Pr ( y \vert X , W ) Pr ( W ) Pr ( W \vert S ) ] = [ {\text{} \sum }_{i = 1}^{k} {y}^{( i )} log [ f ( {X}^{( i )} {W}_{i} ) ] + ( 1 - {y}^{( i )} ) log [ 1 - f ( {X}^{( i )} {W}_{i} ) ] ] + \sum [ - \frac{1}{2} ( {W}^{T} W ) ] + {\sum }_{l = 1}^{m} [ - k log ( {σ}_{l} \sqrt{2 π} ) + {\sum }_{i = 1}^{k} {\sum }_{j = 1}^{k} - {\frac{{S}_{ij}}{2 {σ}_{l}^{2}} [ {W}_{il} - {W}_{jl} ]}^{2} ] + Constant$$

In some embodiments, the above equation may be constrained under the constraint that

Σⱼ₌₁^{k}Sᵢⱼ=1,all Sᵢⱼ≥0, and/or Sᵢᵢ=0.

Turning back to FIG. 3, the process 300 includes, at step/operation 312, updating the particular machine learning model based on the aggregated loss value for the particular machine learning model. For example, the computing system 100 may update the particular machine learning model based on the aggregated loss value for the particular machine learning model. The particular machine learning model, for example, may be updated by modifying one or more coefficients (e.g., represented by the model matrix, and/or the like) of the machine learning model. In some embodiments, the process 300 may further include updating the similarity matrix based on the aggregated loss value. For example, the computing system 100 may update the similarity matrix based on the aggregated loss value.

In this way, the plurality of machine learning models associated with a prediction domain may be jointly trained to optimize model performance. Jointly training the machine learning models, for example, may include simultaneously updating parameters (e.g., coefficients of the model matrix and/or the like) for the machine learning models at one or more iterations of the machine learning training approach. By facilitating the intelligent joint training of the machine learning models, each model may be updated based on inter-model relationships which may improve the predictive capabilities of the models individually and as a group. Moreover, joint training techniques may increase an amount of training data accessible for training each model. For example, similar models may share training data thereby increasing the overall training data available for training each model. This, in turn, may lead to more robust, reliable, and accurate machine learning models. Examples of updating the particular machine learning model based on the aggregated loss value for the particular machine learning model will now be described with reference to FIG. 4.

By way of example, with reference to FIG. 4, the model matrix 404 (e.g., indicative of a set of coefficients for each of the plurality of machine learning models) and/or the similarity matrix 406 may be updated over one or more iterations to optimize (e.g., minimize and/or the like) the aggregated loss value 416. The similarity matrix 406 and/or the model matrix 404, for example, may be updated through one or more machine learning training techniques such as back-propagation of errors. A matrix may be updated using any type of optimization strategy such as those used for backpropagation including, for example, stochastic gradient descent (‘SGD’, with or without momentum), RMSprop, Adam, AdamW, learning rate scheduling, and/or the like. In some embodiments, the similarity matrix 406, S, may be constrained to maintain one or more statistical assumptions. By way of example, the similarity matrix 406, S, may be weighted to represent a probability space. In some embodiments, the back-propagation of the similarity matrix 406 may be constrained by constraining all code similarity values of the similarity matrix 406 to be non-negative and/or by introducing a statistical assumption that each prediction class of the prediction domain is related to an average of number of other prediction classes.

The similarity matrix 406 and the model matrix 404 may be updated over a plurality of training iterations until the matrices reach a state of equilibrium. In some embodiments, the state of equilibrium may be detected in the event that the stepwise change of the model matrix 404, W, and the similarity matrix 406, S, is below a certain epsilon, Q, for more than a threshold number of iterations, N, of the machine learning training approach (e.g., Q=1×10⁷, N=5) and/or in the event that the performance over the training dataset 402 (e.g., represented by the prediction loss matrix) does not improve for a threshold number of iterations of the machine learning training approach.

Turning back to FIG. 3, in some embodiments, the process 300 may include, at step/operation 314, outputting an optimized machine learning model for the prediction domain. For example, the computing system 100 may output a plurality of optimized machine learning models after one or more iterations of the machine learning training approach. In this way, the machine learning training approach may continuously refine the machine learning models to jointly optimize model performance across each of the machine learning models. Once optimized (e.g., performance metrics achieving threshold performance criteria), the process 300 may include outputting a set of optimized machine learning models whose optimized coefficients are represented by the model matrix and have been optimized using optimized similarity measures of the similarity matrix.

### IV. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### V. EXAMPLES

Example 1. A computer-implemented method comprising: generating, by one or more processors, a similarity matrix corresponding to a plurality of machine learning models, wherein the similarity matrix is indicative of a code similarity value between at least two machine learning models of the plurality of machine learning models; generating, by the one or more processors, a sharing loss value for the at least two machine learning models, wherein the sharing loss value is based at least in part on a measured dissimilarity between the at least two machine learning models; generating, by the one or more processors and using a loss function and a training dataset, a prediction loss value for a particular machine learning model of the at least two machine learning models; generating, by the one or more processors, an aggregated loss value for the particular machine learning model based at least in part on the similarity matrix, the sharing loss value, and the prediction loss value; and updating, by the one or more processors, the particular machine learning model based on the aggregated loss value.

Example 2. The computer-implemented method of example 1 further comprising updating, by the one or more processors, the similarity matrix based on the aggregated loss value.

Example 3. The computer-implemented method of example 1 or 2 wherein the particular machine learning model is a first machine learning model that corresponds to a first medical code associated with a first textual description, the at least two machine learning models comprise a second machine learning model that corresponds to a second medical code associated with a second textual description, and generating the similarity matrix comprises generating, by the one or more processors, an initial code similarity value between the at least two machine learning models based on a textual similarity between the first textual description and the second textual description; and initializing, by the one or more processors, the similarity matrix with the initial code similarity value.

Example 4. The computer-implemented method of any of the preceding examples wherein the measured dissimilarity comprises at least one of: (i) a distance between one or more coefficients of the at least two machine learning models or (ii) an output difference between one or more outputs of the at least two machine learning models.

Example 5. The computer-implemented method of any of the preceding examples wherein the sharing loss value is represented by a sharing loss matrix comprising a respective sharing loss value for each pair of machine learning models of the plurality of machine learning models.

Example 6. The computer-implemented method of example 5 wherein generating the aggregated loss value comprises: generating, by the one or more processors, a sharing-similarity loss matrix based on the sharing loss matrix and the similarity matrix, wherein (a) the sharing-similarity loss matrix comprises a sharing-similarity loss value for the at least two machine learning models, and (b) the sharing-similarity loss value comprises the sharing loss value scaled by the code similarity value.

Example 7. The computer-implemented method of example 6 wherein the aggregated loss value for the particular machine learning model is representative of a joint loss for each of the plurality of machine learning models, and wherein the aggregated loss value comprises a weighted sum of (a) a prediction loss matrix comprising a respective prediction loss value for each machine learning model of the plurality of machine learning models and (b) the sharing-similarity loss matrix.

Example 8. The computer-implemented method of any of the preceding examples wherein the prediction loss value for the at least two machine learning models is represented by a prediction loss matrix comprising a respective prediction loss value for each machine learning model of the plurality of machine learning models.

Example 9. The computer-implemented method of any of the preceding examples wherein the plurality of machine learning models are represented by a model matrix, and wherein updating the particular machine learning model comprises updating, by the one or more processors, the model matrix for the plurality of machine learning models to optimize the aggregated loss value.

Example 10. The computer-implemented method of example 9 wherein the model matrix is indicative of a set of coefficients for each of the plurality of machine learning models.

Example 11. A computing apparatus comprising at least one processor and at least one memory including program code, the at least one memory and the program code configured to, upon execution by the at least one processor, cause the apparatus to: generate a similarity matrix corresponding to a plurality of machine learning models, wherein the similarity matrix is indicative of a code similarity value between at least two machine learning models of the plurality of machine learning models; generate a sharing loss value for the at least two machine learning models, wherein the sharing loss value is based at least in part on a measured dissimilarity between the at least two machine learning models; generate, using a loss function and training dataset, a prediction loss value for a particular machine learning model of the at least two machine learning models; generate an aggregated loss value for the particular machine learning model based at least in part on the similarity matrix, the sharing loss value, and the prediction loss value; and update the particular machine learning model based at least in part on the aggregated loss value for the particular machine learning model.

Example 12. The computing apparatus of example 11, further configured to update the similarity matrix based at least in part on the aggregated loss value.

Example 13. The computing apparatus of example 12 wherein the particular machine learning model is a first machine learning model that corresponds to a first medical code associated with a first textual description, the at least two machine learning models comprise a second machine learning model that corresponds to a second medical code associated with a second textual description, and generating the similarity matrix comprises: generating, by the one or more processors, an initial code similarity value between the at least two machine learning models based at least in part on a textual similarity between the first textual description and the second textual description; and initializing, by the one or more processors, the similarity matrix with the initial code similarity value.

Example 14. The computing apparatus of any of examples 11 through 13 wherein the measured dissimilarity comprises at least one of: (i) a distance between one or more coefficients of the at least two machine learning models or (ii) an output difference between one or more outputs of the at least two machine learning models.

Example 15. A non-transitory computer-readable storage medium comprising instructions that, when executed by one or more processors, cause the one or more processors to: generate a similarity matrix corresponding to a plurality of machine learning models, wherein the similarity matrix is indicative of a code similarity value between at least two machine learning models of the plurality of machine learning models; generate a sharing loss value for the at least two machine learning models, wherein the sharing loss value is based at least in part on a measured dissimilarity between the at least two machine learning models; generate, using a loss function and training dataset, a prediction loss value for a particular machine learning model of the at least two machine learning models; generate an aggregated loss value for the particular machine learning model based at least in part on the similarity matrix, the sharing loss value, and the prediction loss value; and update the particular machine learning model based at least in part on the aggregated loss value for the particular machine learning model.

Example 16. The non-transitory computer-readable storage medium of example 15 wherein the sharing loss value is represented by a sharing loss matrix comprising a respective sharing loss value for each pair of machine learning models of the plurality of machine learning models.

Example 17. The non-transitory computer-readable storage medium of example 16 wherein generating the aggregated loss value comprises: generating a sharing-similarity loss matrix based at least in part on the sharing loss matrix and the similarity matrix, wherein (a) the sharing-similarity loss matrix comprises a sharing-similarity loss value for the at least two machine learning models, and (b) the sharing-similarity loss value comprises the sharing loss value scaled by the code similarity value.

Example 18. The non-transitory computer-readable storage medium of example 17 wherein the prediction loss value for the at least two machine learning models is represented by a prediction loss matrix comprising a respective prediction loss value for each machine learning model of the plurality of machine learning models.

Example 19. The non-transitory computer-readable storage medium of example 18 wherein the aggregated loss value for the particular machine learning model is representative of a joint loss for each of the plurality of machine learning models, and wherein the aggregated loss value comprises a weighted sum of (a) a prediction loss matrix comprising a respective prediction loss value for each machine learning model of the plurality of machine learning models and (b) the sharing-similarity loss matrix.

Example 20. The non-transitory computer-readable storage medium of any of examples 15 through 19 wherein the plurality of machine learning models are represented by a model matrix, and wherein updating the particular machine learning model comprises: updating the model matrix for the plurality of machine learning models to optimize the aggregated loss value.

1. A computer-implemented method comprising:
generating, by one or more processors, a similarity matrix corresponding to a plurality of machine learning models, wherein the similarity matrix is indicative of a code similarity value between at least two machine learning models of the plurality of machine learning models;
generating, by the one or more processors, a sharing loss value for the at least two machine learning models, wherein the sharing loss value is based at least in part on a measured dissimilarity between the at least two machine learning models;
generating, by the one or more processors and using a loss function and a training dataset, a prediction loss value for a particular machine learning model of the at least two machine learning models;
generating, by the one or more processors, an aggregated loss value for the particular machine learning model based at least in part on the similarity matrix, the sharing loss value, and the prediction loss value; and
updating, by the one or more processors, the particular machine learning model based on the aggregated loss value.

2. The computer-implemented method of claim 1 further comprising:
updating, by the one or more processors, the similarity matrix based on the aggregated loss value.

3. The computer-implemented method of claim 1, wherein:
the particular machine learning model is a first machine learning model that corresponds to a first medical code associated with a first textual description,
the at least two machine learning models comprise a second machine learning model that corresponds to a second medical code associated with a second textual description, and
generating the similarity matrix comprises:
generating, by the one or more processors, an initial code similarity value between the at least two machine learning models based on a textual similarity between the first textual description and the second textual description; and
initializing, by the one or more processors, the similarity matrix with the initial code similarity value.

4. The computer-implemented method of claim 1, wherein the measured dissimilarity comprises at least one of: (i) a distance between one or more coefficients of the at least two machine learning models or (ii) an output difference between one or more outputs of the at least two machine learning models.

5. The computer-implemented method of claim 1, wherein the sharing loss value is represented by a sharing loss matrix comprising a respective sharing loss value for each pair of machine learning models of the plurality of machine learning models.

6. The computer-implemented method of claim 5, wherein generating the aggregated loss value comprises:
generating, by the one or more processors, a sharing-similarity loss matrix based on the sharing loss matrix and the similarity matrix, wherein (a) the sharing-similarity loss matrix comprises a sharing-similarity loss value for the at least two machine learning models, and (b) the sharing-similarity loss value comprises the sharing loss value scaled by the code similarity value.

7. The computer-implemented method of claim 6, wherein the aggregated loss value for the particular machine learning model is representative of a joint loss for each of the plurality of machine learning models, and wherein the aggregated loss value comprises a weighted sum of (a) a prediction loss matrix comprising a respective prediction loss value for each machine learning model of the plurality of machine learning models and (b) the sharing-similarity loss matrix.

8. The computer-implemented method of claim 1, wherein the prediction loss value for the at least two machine learning models is represented by a prediction loss matrix comprising a respective prediction loss value for each machine learning model of the plurality of machine learning models.

9. The computer-implemented method of claim 1, wherein the plurality of machine learning models are represented by a model matrix, and wherein updating the particular machine learning model comprises:
updating, by the one or more processors, the model matrix for the plurality of machine learning models to optimize the aggregated loss value.

10. The computer-implemented method of claim 9, wherein the model matrix is indicative of a set of coefficients for each of the plurality of machine learning models.

11. A computing apparatus comprising at least one processor and at least one memory including program code, the at least one memory and the program code configured to, upon execution by the at least one processor, cause the apparatus to:
generate a similarity matrix corresponding to a plurality of machine learning models, wherein the similarity matrix is indicative of a code similarity value between at least two machine learning models of the plurality of machine learning models;
generate a sharing loss value for the at least two machine learning models, wherein the sharing loss value is based at least in part on a measured dissimilarity between the at least two machine learning models;
generate, using a loss function and training dataset, a prediction loss value for a particular machine learning model of the at least two machine learning models;
generate an aggregated loss value for the particular machine learning model based at least in part on the similarity matrix, the sharing loss value, and the prediction loss value; and
update the particular machine learning model based at least in part on the aggregated loss value for the particular machine learning model.

12. The computing apparatus of claim 11, further configured to:
update the similarity matrix based at least in part on the aggregated loss value.

13. The computing apparatus of claim 12, wherein:
the particular machine learning model is a first machine learning model that corresponds to a first medical code associated with a first textual description,
the at least two machine learning models comprise a second machine learning model that corresponds to a second medical code associated with a second textual description, and
generating the similarity matrix comprises:
generating, by the one or more processors, an initial code similarity value between the at least two machine learning models based at least in part on a textual similarity between the first textual description and the second textual description; and
initializing, by the one or more processors, the similarity matrix with the initial code similarity value.

14. The computing apparatus of claim 11, wherein the measured dissimilarity comprises at least one of: (i) a distance between one or more coefficients of the at least two machine learning models or (ii) an output difference between one or more outputs of the at least two machine learning models.

15. A non-transitory computer-readable storage medium including instructions that, when executed by one or more processors, cause the one or more processors to:
generate a similarity matrix corresponding to a plurality of machine learning models, wherein the similarity matrix is indicative of a code similarity value between at least two machine learning models of the plurality of machine learning models;
generate a sharing loss value for the at least two machine learning models, wherein the sharing loss value is based at least in part on a measured dissimilarity between the at least two machine learning models;
generate, using a loss function and training dataset, a prediction loss value for a particular machine learning model of the at least two machine learning models;
generate an aggregated loss value for the particular machine learning model based at least in part on the similarity matrix, the sharing loss value, and the prediction loss value; and
update the particular machine learning model based at least in part on the aggregated loss value for the particular machine learning model.

16. The non-transitory computer-readable storage medium of claim 15, wherein the sharing loss value is represented by a sharing loss matrix comprising a respective sharing loss value for each pair of machine learning models of the plurality of machine learning models.

17. The non-transitory computer-readable storage medium of claim 16, wherein generating the aggregated loss value comprises:
generating a sharing-similarity loss matrix based at least in part on the sharing loss matrix and the similarity matrix, wherein (a) the sharing-similarity loss matrix comprises a sharing-similarity loss value for the at least two machine learning models, and (b) the sharing-similarity loss value comprises the sharing loss value scaled by the code similarity value.

18. The non-transitory computer-readable storage medium of claim 17, wherein the prediction loss value for the at least two machine learning models is represented by a prediction loss matrix comprising a respective prediction loss value for each machine learning model of the plurality of machine learning models.

19. The non-transitory computer-readable storage medium of claim 18, wherein the aggregated loss value for the particular machine learning model is representative of a joint loss for each of the plurality of machine learning models, and wherein the aggregated loss value comprises a weighted sum of (a) a prediction loss matrix comprising a respective prediction loss value for each machine learning model of the plurality of machine learning models and (b) the sharing-similarity loss matrix.

20. The non-transitory computer-readable storage medium of claim 15, wherein the plurality of machine learning models are represented by a model matrix, and wherein updating the particular machine learning model comprises:
updating the model matrix for the plurality of machine learning models to optimize the aggregated loss value.
